(19) United States
(12) Patent Application Publication
(10) Pub. No.: US 2009/0138890 A1
(43) Pub. Date: May 28, 2009

(54) Contention management for a hardware transactional memory

(75) Inventors: Geoffrey Blake, Ann Arbor, MI (US); Trevor Nigel Mudge, Ann Arbor, MI (US); Stuart David Biles, Suffolk (GB); Nathan Yong Seng Chong, Cambridge (GB); Emre Ozer, Cambridge (GB); Ronald George Dreslinski, Sterling Heights, MI (US)

Correspondence Address: NIXON & VANDERHYE P.C., 901 N. Glebe Road, 11th Floor, Arlington, VA, 22203-1808, US

(73) Assignee: ARM LIMITED, Cambridge (GB)

(21) Appl. No.: 12/292,565

(22) Filed: Nov. 20, 2008

Related U.S. Application Data
(63) Continuation-in-part of application No. 12/149,003, filed on Apr. 24, 2008.
(60) Provisional application No. 60/989,734, filed on Nov. 21, 2007.

(51) Int. Cl. G06F 9/46

(52) U.S. Cl. 718/106

(57) ABSTRACT

A hardware transactional memory 12, 14, 16, 18, 20 is provided within a multiprocessor 4, 6, 8, 10 system with coherency control and hardware transaction memory control circuitry 22 that serves to at least partially manage the scheduling of processing transactions in dependence upon conflict data 26, 28, 30. The conflict data characterises previously encountered conflicts between processing transactions. The scheduling is performed such that a candidate processing transaction will not be scheduled if the conflict data indicates that one of the already running processing transactions has previously conflicted with the candidate processing transaction.

### BACKGROUND OF THE INVENTION

1. Field of the Invention

This invention relates to the field of data processing systems. More particularly, this invention relates to the field of contention management within hardware transactional memories.

2. Description of the Prior Art

It is desirable to perform parallel processing of program code. As multi-processor systems have become more widely available, the use of parallel processing of computer programs has become wide spread. Whilst such parallel processing can significantly improve performance, it suffers from the disadvantage of an increased complexity in the writing computer programs suitable for parallel execution. One technique uses software locks to enforce exclusive access to data items so as to avoid different portions of a computer program being executed in parallel inappropriately interfering with each other. A difficulty of this approach is that the programs must be written to set and reset the locks at appropriate times; this is a complex and error prone task.

An alternative approach to facilitating the parallel processing of computer programs is the use of a transactional memory. With this approach a computer program can be considered to be broken down into two distinct types of entities. These are “processing threads” and “processing transactions”. A “processing thread” is a piece of computer code that runs on a single processor concurrently with code running on other processors. A “processing transaction” is a piece of work that is executed by a thread, where memory accesses performed by the transaction appear atomic as far as other threads and transactions are concerned. A single thread can execute many transactions.

A transactional memory system may be implemented fully as a software layer, fully in hardware or a combination of the two. For the purposes of this description, a hardware transactional memory system is understood to have at least some hardware features supporting the transactional memory model. Whilst the description focuses on a hardware transaction memory system, the invention is applicable to a software only transactional memory system.

A hardware transactional memory serves to identify conflicts arising between processing transactions, e.g. read-after-write hazards. If such a conflict arises where two processing transactions seek to access the same data, then the hardware transactional memory triggers an abort of at least one of the processing transactions and the restoring of the state prior to initiation of that processing transaction. The scheduling mechanisms within the data processing system will then reschedule that processing transaction to be executed at a later time, this later time typically being determined on the basis of an exponential backoff whereby the scheduling mechanism suspends the transaction for a time before it is rescheduled to provide the opportunity for the conflict to be removed by completion of the conflicting processing transaction. If the rescheduled processing transaction conflicts again, then it can again be aborted and rescheduled after an exponentially increased delay.

### SUMMARY OF THE INVENTION

Viewed from one aspect the present invention provides a method of processing data using a plurality of processors and a transactional memory, said method comprising the steps of:

detecting with said transactional memory conflict arising between concurrent processing transactions executed by respective processors accessing shared data within said transactional memory;

in response to said conflicts, storing conflict data for respective processing transactions indicative of with which other processing transactions a conflict has previously been detected; and

scheduling processing transactions to be executed in dependence upon said conflict data.

The present technique uses conflict data indicative of processing transactions between which conflicts have previously been detected so as to control the scheduling of future processing transactions. Thus, the scheduling may be considered to “learn” from past behaviour and schedule the processing transactions as to use the hardware transactional memory in a manner which reduces the likelihood of future conflicts arising and thereby increases the efficiency of operation of the overall system.

A transactional memory system may be implemented fully as a software layer, fully in hardware or a combination of the two for the purposes of the present technique, most implementations will feature a hardware element, but a software scheme could benefit e.g. determine conflict in software, update conflict tables; potentially provide a mask checking instruction in the hardware that traps to a software handler, a fully software approach is also possible.

The transactional memory can facilitate the forming of the conflict data by providing a transaction identifier indicative of a processing transaction with which a conflict has arisen. Using the transactional memory to provide a transaction identifier in this way simplifies the task of subsequently forming the conflict data.

The hardware transactional memory can store the transaction identifier within at least one of a dedicated transaction identifier register, a general purpose register within a register bank and a memory location (e.g. a predetermined location known to the transactional memory runtime software or pushed onto a stack (possibly with other exception state)). As a conflict has arisen, the current context of a register bank will generally be treated as corrupt and will be restored as part of the abort process. Accordingly, the use a of a general purpose register for storing the transaction identifier generated by the hardware transactional memory will not overwrite any data value which needs to be kept within the register bank.

Whilst the conflict data could be generated entirely by hardware mechanisms, it is convenient in at least some embodiments to use conflict software to form the conflict data including reading the transaction identifier which is generated by the hardware transactional memory.

The scheduling in dependence upon the conflict data can be performed by scheduling software, scheduling hardware or a combination of scheduling software and scheduling hardware.

It will be appreciated that the conflict data can have a wide variety of different forms. In one form the conflict data comprises a plurality of transaction entries, each transaction entry corresponding to a processing transaction and storing data at least indicative of one or more processing transactions with which said processing transaction has previously conflicted. In this way, previously conflicting processing transactions can be stored on a transaction-by-transaction basis.

In order to speed conflict prediction (which may be performed in hardware), each transaction entry may include a summary conflict entry indicative of one or more processing transactions with which the processing transaction of that transaction entry has previously conflicted. The scheduling process can compare this summary conflict entry for a candidate processing transaction to be scheduled with corresponding summary status data indicative of currently executing processing transactions so as to identify any potential conflict(s).

The summary data can be formed in a way which can give false positives (i.e. indicate a potential conflict when upon detailed examination no conflict will arise), but will not give a negative unless the full data also indicates a negative. As the majority of scheduling operations will not result in a conflict, this is a useful feature as it can enable non-conflict situations to be rapidly and efficiently identified with the rarer potential conflict situations being referred for further analysis.

Such further analysis is facilitated in embodiments in which each transaction entry includes a conflict list having respective entries for each of the one or more processing transactions with which said processing transaction has previously conflicted. After a match with the summary conflict entry, this conflict list data can be compared with a corresponding list of the currently executing processing transactions to confirm whether or not a conflict does exist. Thus, the summary information identifies a potential conflict (e.g. in hardware) and the list information serves to confirm or not confirm (e.g. in software) such potential conflicts.

The storage space required for the conflict data may be reduced in other embodiments in which each transaction entry within the conflict data corresponds to a plurality of processing transactions and stores data indicative of one or more processing transactions with which any of the plurality of processing transactions has previously conflicted. It will be appreciated that there is a balance between the storage requirements of the conflict data and the occurrence of false positives identifying conflicts for a processing transaction whereas in reality the previously detected conflict was between a different pair of processing transactions.

The information regarding which processing transactions are currently executing upon the plurality of processes may be provided by storing status data. The scheduling operation can compare the status data with the conflict data of a candidate processing transaction to identify if any of the currently executing processing transactions have previously conflicted with the candidate processing transaction.

The status data can include summary status data indicative of which processing transactions are currently executing upon the plurality of processors. As previously discussed, this summary status entry may be compared with summary conflict entry data of a candidate processing transaction to identify potential conflicts.

The transaction identifier can have a wide variety of different forms. In one form it is dependent upon a thread identifier associated with a processing transaction giving rise to a conflict and a program counter value corresponding to a starting program address of the processing transaction giving rise to the conflict. This combination provides a good degree of specificity with respect to the processing transaction. This specificity can be further enhanced by forming the transaction identifier to be dependent upon one or more of at least one input data value to the processing transaction and at least one memory address value accessed by the processing transaction.

In some embodiments, the processors may be modified to be responsive to a native program instruction to trigger a check using the conflict data for a potential conflict with any currently executing processing transaction. Thus, the processors can provide hardware support to facilitate more efficient use (and potentially generation) of the conflict data in managing conflicts and controlling the scheduling within a hardware transactional memory system.

The check for conflicts may be performed with an initial stage under hardware control and comparing summary data with a further stage performed under software control to confirm a conflict if a potential conflict is identified by the initial stage.

The scheduling of processing transactions in dependence upon the conflict data, and in particular the rescheduling of processing transactions which have been delayed due to identification of a potential conflict, represents a system overhead. This system overhead can be more readily supported in embodiments in which a call is made to at least one of an operating system and scheduling software to trigger attempting rescheduling of processing transactions for which the conflict data previously indicated a potential conflict.

The processing to be performed may be divided into a plurality of processing threads with at least one of the processing threads comprising one or more processing transactions. Within such a system it may be desirable that at least one of an operating system and scheduling software serve to trigger attempted rescheduling of processing transactions for which the conflict data previously indicated a potential conflict.

The processing to be performed may be divided into a plurality of processing threads with at least one of the processing threads comprising one or more processing transactions. Within such a system it may be desirable that at least one of an operating system and scheduling software acts upon data characterising one or more of which threads exist to be scheduled, which threads are currently running, which threads are waiting to be scheduled and which threads cannot currently be scheduled due to a potential conflict indicated by the conflict data.

In some embodiments when an executing processing transaction completes a search operation can be performed to identify any blocked processing transactions that were being prevented from being scheduled as the conflict data indicated a potential conflict with the executing processing transaction which has just completed. If any such blocked processing transactions are identified, then they can be marked so as to be released and eligible for future scheduling.

Management of the processing threads may be performed using an operating system which controls issue of processing threads marked as active and does not issue processing threads marked as pended. The scheduling software may be responsive to the conflict data to update the marking of processing threads as either active of pended.

When a conflict arises during execution of a processing transaction that is then aborted, the scheduling software can call the operating system to mark the processing thread including the aborted processing transaction as a pended processing thread. When such a processing thread has been marked as pended and the processing transaction aborted, the operating system can then search for a processing thread to issue in its place.

It will be appreciated by those in the field that the plurality of processors which interact with the transactional memory could be in the form of a plurality of logical processors provided by a multithreading processor supporting simultaneous multithreading that interleaves execution of program instructions corresponding to different concurrent processing transactions. Such multithreading processors provide parallelism using a single piece of hardware which behaves as if it were multiple logical processors. As an example, alternate processing cycles may execute program instructions from different threads such that the two threads are interleaved and each appears to be executing on its own individual logical processor. In an alternative embodiment, groups of program instructions from each thread may be executed in turn.

In the context of such multithreading processors, the step of scheduling which is controlled in dependence upon the conflict data may take the form of selecting for which of a plurality of processing transactions program instructions are fetched from memory for execution by the multithreading processor. In this way, program instructions will not be fetched for processing transactions which are predicted to conflict with an already executing processing transaction such that the energy and effort wasted in needlessly fetching such conflicting program instructions will be avoided.

The scheduling may take the form of selecting one of a plurality of processing transactions to be fetched and blocking fetching for the candidate processing transaction if the conflict data indicates a conflict has previously occurred with an already executing processing transaction. In this way, conventional mechanisms for the selection of the candidate processing transaction may be used and the conflict data employed to block fetching if it predicts a conflict. In such circumstances, the scheduling can react to a blocked candidate processing transaction by proceeding to select a different processing transaction from a plurality of processing transactions to be used as the candidate processing transaction.

In other embodiments the scheduling can be preemptively responsive to the conflict data and detect respective likelihoods for a plurality of candidate processing transactions of a conflict arising with a currently processing transaction and then select the processing transaction for which program instructions are to be fetched in dependence upon these detected likelihoods.

The selection of the processing transaction to be fetched may also be dependent upon respective priority levels associated with the plurality of candidate processing transactions. It will be appreciated that the selection may thus be made upon a combined measure of the relative priority and the relative likelihood of conflict. Those in this technical field will appreciate there is a balance between the complexity of the control of processing transaction selection weighed against the merit of having the highest priority processing transactions preferentially selected in circumstances where there is unacceptable likelihood of conflict.

In some circumstances the step of scheduling may serve to identify a conflict between a candidate processing transaction and a currently executing program instruction and then if the priority of the candidate processing transaction is sufficiently high serve to stop execution of the currently executing transaction such that the candidate processing transaction can be executed instead.

The conflict data may also be used to identify when a suspended processing transaction that conflicted with another processing transaction can be rescheduled as that another processing transaction has completed. In this way, a suspended processing transaction can be scheduled without undue delay once the cause of the potential conflict has been removed. This is a more sophisticated and higher performance approach than merely attempting rescheduling a suspended processing transaction at some fixed or random delay period following the detection of the conflict.

The transactional memory can include a conflict data cache memory storing at least a portion of the conflict data indicative of the previously detected conflicts between processing transactions. Providing such hardware support for storing the conflict data enables the prediction of conflict within a transaction memory system to be identified (with the associated performance benefits) whilst reducing the overhead associated with the operating system or other mechanisms which normally control scheduling as an increase of overhead within such software mechanisms could otherwise degrade performance.

Whilst the conflict data cache may be provided in a wide variety of forms and store data in a wide variety of different forms, one efficient approach is where each entry in the conflict data cache corresponds to a pair of processing transactions between which a conflict has previously been detected. In this context, the conflict data cache can have a tag indicative of a pair of processing transactions between which conflict has previously been detected and the data held within the conflict data cache for that entry can be a prediction of the likelihood of a future conflict, e.g. a saturating counter or other measure indicating how strong the prediction of conflict is based upon how many times it has previously been detected.

Storage space within the conflict data cache may be saved in embodiments in which the conflict data identifies processing transactions non-uniquely using a hash value derived from a transaction identifier. Such an approach will likely result in an increase in false positives for conflict prediction, but may reduce the storage overhead in the conflict data cache. In alternative embodiments the identification within the conflict data cache may uniquely identify processing transactions using transaction identifiers.

Tag generating circuitry may be provided to store data indicative of currently executing processing transactions and to be responsive to an identifier for a candidate processing transaction to be scheduled to generate tag data in respect of combinations of that candidate processing transaction and the currently executing processing transactions such that the tag data can be supplied to the conflict data cache to look up if any conflict has previously been detected between the candidate processing transaction and any of the currently executing processing transactions. Such tag generating circuitry in combination with the conflict data cache provides a high performance hardware technique for accessing conflict data that can be used to predict conflicts within a transaction memory system without requiring operating system or other software support.

The tag generating circuitry may serve to store a table of transaction identifiers identifying the currently executing processing transactions. The stored transaction identifiers may be combined (for instance concatenated) with a transaction identifier of a candidate processing transaction to form a tag which is then used to index into the conflict data cache.

The conflict data cache may have a variety of forms such as fully associative, set associative or direct mapped. These different forms of conflict data cache have different advantages and disadvantages making them suitable for particular circumstances as will be appreciated by those in this technical field.

In some embodiments when a hit occurs within the conflict data cache, the scheduling of a candidate processing transaction corresponding to that hit may be suspended. In some embodiments the suspension of the scheduling of the candidate processing transaction may be performed completely or partially by hardware. In other words, the suspension of the scheduling of the candidate processing transaction may be achieved by issuing an interrupt to an operating system. Thus, whilst the bulk of the prediction of conflicts from the conflict data is performed in hardware, the relatively infrequent need to suspend a candidate processing transaction may be performed by the operating system software when appropriately triggered by an interrupt. Thus, the overhead of providing a mechanism to suspend scheduling need not be incurred by the hardware and yet the operating system can support this behaviour with a relatively low impact on performance since the behaviour should be rare.

The tag generating circuitry may serve to generate its tags in response to transaction identifying signals received from the plurality of processors indicative of which processing transactions they are currently executing. The processors broadcast the tag identifiers to one another (when they start a transaction (i.e. it passes its own prediction stage) or when a suspended transaction is restarted under software control) with the tag generating circuitry associated with each processor then using this broadcast information to track the behaviour of the other processors and combine it with its own behaviour when trying to schedule a candidate processing transaction.

Suspended processing transaction circuitry may be provided in some embodiments to store date identifying candidate processing transactions not scheduled due to at least one of a detected conflict or a detected potential conflict. Providing suspended processing transaction circuitry to record such information enables a hardware mechanism to be used to identify when the reason for the suspension has been removed and accordingly trigger rescheduling. This is facilitated by storing within the suspended transaction processing circuitry data identifying for each suspended candidate processing transaction a currently executing processing transaction with which the conflict or potential conflict was identified.

The processor(s) may in some embodiments broadcast signals indicative of finishing execution of a processing transaction and this may be used to update the contents of the tag generating circuitry and/or the suspended processing transaction circuitry. More particularly, when a processing transaction with which a conflict was predicted finishes, this may trigger the scheduling of one or more suspended candidate processing transactions stored within the suspended transaction processing circuitry as these should now be able to be processed without conflict.

The scheduling of suspended candidate processing transactions may be initiated by issuing an interrupt to an operating system as the operating system will provide a relatively effective way of conducting such scheduling of suspended processing transactions since this should be rare. The scheduling of suspended processing transactions may also be performed by hardware. The overhead associated with such scheduling of suspended processing transactions can be reduced when multiple rescheduling requests resulting from one processing transaction finishing are concatenated into a single interrupt.

The use of the hardware support mechanisms, such as the conflict data cache and the suspended transaction processing circuitry may be used within a multithreaded processor.

The control of scheduling within a multithreaded processor may take the form of blocking fetching of program instructions for a particular processing transaction or alternatively may take the form of the blocking of the issuing of processing instructions of a particular transaction into the execution pipeline.

Whilst the above describes the possibility of the conflict data containing entries identifying a potential conflict between an individual pair of processing transactions, it is also possible to have embodiments in which the conflict data cache contains entries each storing global conflict data in respect of a candidate processing transaction to identify any other processing transactions with which a conflict has previously been detected.

Viewed from another aspect the present invention provides apparatus for processing data comprising:

a plurality of processors;

a transactional memory configured to detect conflicts arising between concurrent processing transactions executed by respective processors accessing shared data within said transactional memory;

a conflict data store responsive to said conflicts to store conflict data for respective processing transactions indicative of with which other processing transactions a conflict has previously been detected; and

scheduling circuitry responsive to said conflict data to schedule processing transactions to be executed.

It will be appreciated that at least the conflict data store and the scheduling circuitry could be provided with dedicated hardware or general purpose hardware operating under software control or a mixture.

The above, and other objects, features and advantages of this invention will be apparent from the following detailed description of illustrative embodiments which is to be read in connection with the accompanying drawings.

### BRIEF DESCRIPTION OF THE DRAWINGS

FIG. 1 schematically illustrates an integrated circuit comprising a plurality of processors and a hardware transactional memory;

FIG. 2 is a diagram schematically illustrating the relationship between a scheduling runtime computer program and other elements within the processing system;

FIG. 3 is a diagram schematically illustrating the structure of conflict data indicative of previously encountered conflicts between transactions;

FIG. 4 is a diagram schematically illustrating the structure of status data indicative of the status of currently executing processing transactions upon the plurality of processors;

FIG. 5 is example code for scheduling a transaction to either run or block waiting for a conflicting transaction to finish together with code that is executed when a transaction completes;

FIG. 6 is a flow diagram schematically illustrating processing performed when a memory access operation is requested so as to identify conflicts between processing transactions;

FIG. 7 is a flow diagram schematically illustrating a scheduling operation for a candidate processing transaction to determine whether or not there is a conflicting transaction which is already running;

FIG. 8 illustrates how a transaction identifier may be formed;

FIG. 9 schematically illustrates code corresponding to a processing transaction with native program instructions at the start and end serving to trigger a conflict check;

FIG. 10 illustrates tag generating circuitry for generating tag data for addressing a conflict data cache;

FIG. 11 illustrates a conflict data cache storing conflict data indicative of previously detected conflicts between processing transactions;

FIG. 12 illustrates suspended transaction processing circuitry storing data identifying for each suspended processing transaction a currently executing processing transaction with which a conflict was predicted or detected;

FIG. 13 illustrates a transaction conflict predictor for use with a system including a transactional memory;

FIG. 14 illustrates a simultaneous multithreading processor incorporating a transaction conflict predictor in accordance with a first embodiment; and

FIG. 15 illustrates a simultaneous multithreading processor incorporating a transaction conflict predictor in accordance with a second embodiment.

### DESCRIPTION OF THE PREFERRED EMBODIMENTS

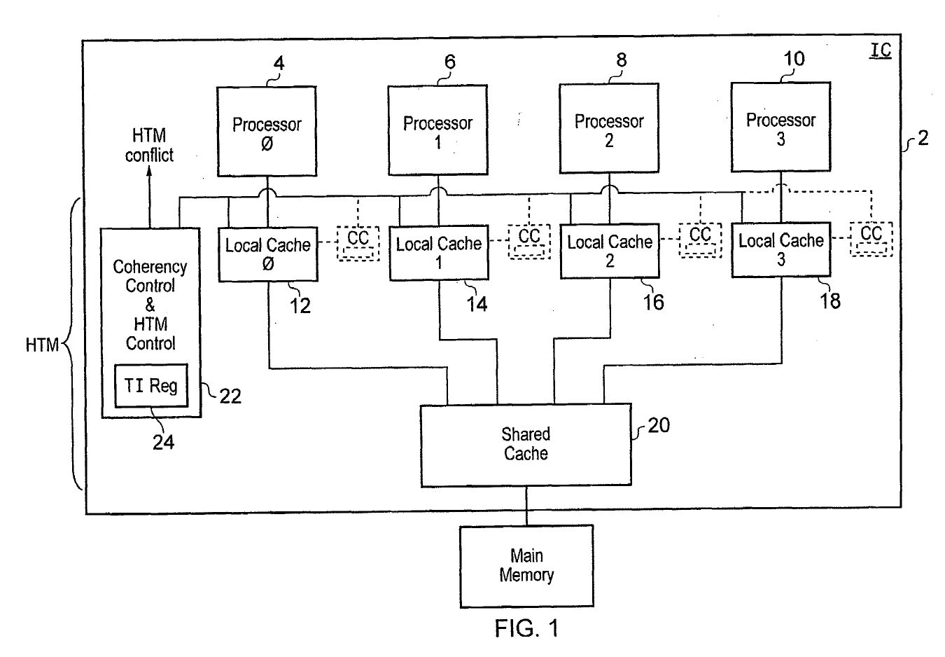

FIG. 1 schematically illustrates an integrated circuit 2 including four processors 4, 6, 8, 10 which share a hardware transactional memory comprises respective local caches 12, 14, 16, 18 and a shared cache 20. Coherency control and hardware transactional memory control circuitry 22 is provided coupled to the local caches 12, 14, 16, 18 to support cache coherency between the local caches 12, 14, 16, 18 in accordance with conventional techniques as well as supporting hardware transactional memory control. When respective different processors 4, 6, 8, 10 seek to access a data value within the hardware transactional memory 12, 14, 16, 18, 20 in a manner which violates coherency requirements (e.g. a read-after-write hazard etc), then this is identified by the coherency control and hardware transactional memory control circuitry 22 and a hardware transactional memory conflict signal is issued to trigger appropriate recovery processing, such as aborting the processing transaction which has given rise to the conflict and restoring the state on the processor which was executing that aborted transaction back to the point prior to the start of execution of that aborted transaction. Conflict data characterising previously encountered conflicts will also be updated.

Compared with conventional cache coherency control mechanisms, the system of FIG. 1 is modified such that when a processor 4, 6, 8, 10 is to abort a transaction due to a detected conflict, it receives a transaction identifier for the processing transaction that cause it to be aborted for storing within a transaction identifier register 24. The action of transmitting the transaction identifier from the conflicting processor to the aborting processor can be a hardware controlled and performed process. This transaction identifier can then be read from the transaction identifier register 24 when forming the conflict data (in dependence upon which scheduling of processing transactions and threads is subsequently performed). The transaction identifier may also be stored with a general purpose register of a register bank with the aborting processor. The aborting transaction will typically be performing a significant amount of other “housekeeping” operations at this time as part of the abort process and so the additional task of updating the conflict data will have little additional impact.

The transaction identifiers are assigned in advance in software (e.g. in the scheduling runtime described below). The software can, for example, read a thread identifier and a program counter value (PC) and hash this into a value that is then written into a register as the transaction identifier. The software could also assign the transaction identifiers arbitrarily and/or they may be defined by a programmer. Another possible embodiment would be for the hardware to read a thread identifier and program counter value from respective registers and then perform a hash. In other embodiments the hardware could generate the transaction identifier itself in response to instructions embedded in the instruction stream (e.g. TMSTART, TMEND) using hardware access to a thread identifier register and the program counter value of the TMSTART instruction.

As illustrated in FIG. 1, centralised coherency control and hardware transactional memory control circuitry 22 is provided. It will be appreciated that as an alternative it would be possible to provide separate coherency control and hardware transactional memory control circuitry associated with each of the local cache memories 12, 14, 16, 18. This is illustrated by the dotted line boxes in FIG. 1. In this alternative case, each of the local coherency control and hardware transactional memory control circuitry can include a transaction identifier register to which the transaction identifier of an aborting processing transaction can be reported when the processor concerned is executing the processing transaction against which the conflict has arisen.

The reporting of the transaction identifier in these example embodiments is that the aborting processing transaction receives the transaction identifier from the conflicting processor/thread which is not aborted. When the transaction identifier of the aborted processing transaction is read later, the identity of any processing transaction against which it conflicted can be identified by the operating system and/or scheduling software which is responsible for forming the conflict data.

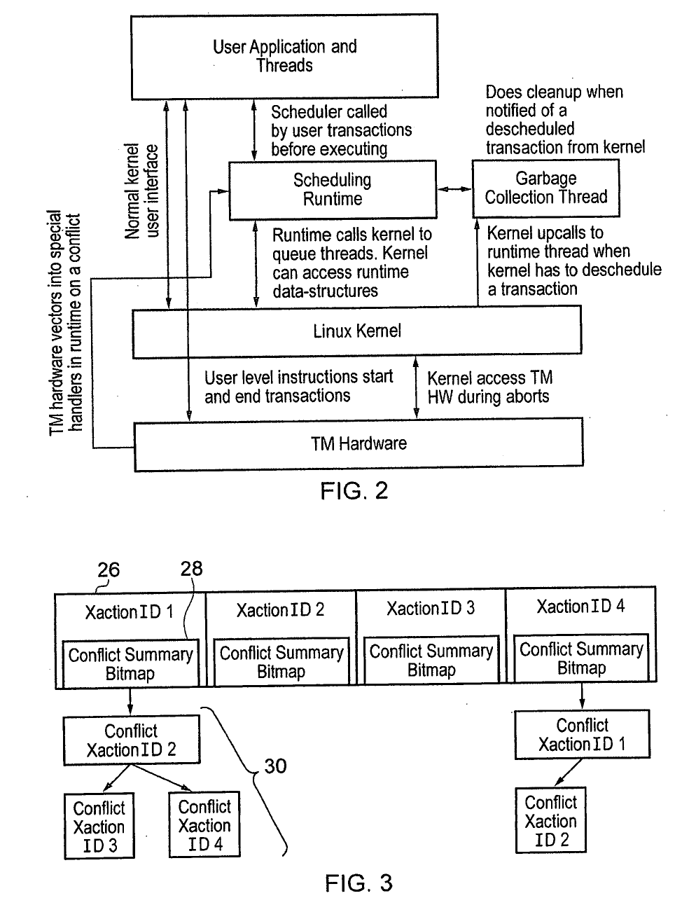

FIG. 2 schematically illustrates the relationship of scheduling runtime software with other elements within the system. In this example embodiment, the scheduling software in the form of the scheduling runtime deals with two distinct types of entities namely “processing threads” and “processing transactions”. A “processing thread” is a piece of computer code that runs on a single processor concurrently with code running on other processors. A “processing transaction” is a piece of work that is executed by a thread, where memory accesses performed by the transaction appear atomic as far as other threads and transactions are concerned. A single thread can execute many transactions.

The scheduling runtime performs transaction scheduling and exists as middleware between the operating system and the user application. The scheduling runtime itself exists in user space to facilitate quick access. In FIG. 2, the interconnections and text illustrate how each piece of the system interacts in this example embodiment. The scheduling runtime is called when the user application wants to schedule a transaction, and then afterwards normal interactions with the hardware transactional memory (TM Hardware) and the operating system proceed. The operating system and the scheduling runtime store/manage data characterising which threads exist to be scheduled, which threads are currently running, which threads are waiting to be scheduled and which threads cannot currently be scheduled due to a potential conflict indicated by the conflict data. The operating system and scheduling runtime will store and manage other data in addition to the above.

When an executing processing transaction completes, the scheduling runtime performs a search operation to identify any blocked processing transactions that were being prevented from being scheduled as the conflict data indicated a potential conflict with the executing processing transaction which has just completed. (It will be appreciated that there are other situations where such a wakeup search can be performed. For example, when a transaction is aborted due to a conflict and the system must determine another thread to be scheduled; regularly on a time tick; etc.) In this case, any so identified blocked processing transaction can then be released so as to be eligible for scheduling. A blocked processing transaction can be marked as “pended” and a processing transaction released and available for scheduling can be marked as “active”. When a conflict arises during execution of a processing transaction that is then aborted, the scheduling runtime can call the operating system to mark the processing thread concerned as a pended processing thread. As this processing thread has been aborted, a processor will be available to perform other processing operations and accordingly the operating system searches for a processing thread to issue to that processor in place of the pended processing thread. The occurrence of a conflict can be used to trigger a call to at least one of the operating system or the scheduling runtime to trigger attempted rescheduling of processing transactions for which the conflict data had previously indicated a potential conflict (i.e. those processing transactions are part of a pended processing thread). This can provide a mechanism whereby pended processing threads (potentially conflicting processing transactions) are resubmitted as candidate processing transactions for rescheduling at a later time.

FIG. 3 schematically illustrates conflict data which can be used by the scheduling runtime to at least partially control the scheduling of processing transactions (within processing threads). This conflict data includes a transaction entry 26 for each processing transaction where a conflict has previously been identified. Processing transactions where no conflict has previously been identified need not have an entry within the conflict data.

The transaction entry includes summary conflict data 28, which can be generated by a hash function, such as a Bloom filter, to summarise the entries in the conflict list data 30 for that transaction entry. The conflict data of FIG. 3 is used to predict which transactions will conflict in the future by using past conflict history. The conflict data may be provided in the form of a table structured such as a hashed table that is indexed by a hash of the transaction ID for the processing transaction upon which a conflict check is being performed.

As an initial stage of the check the summary conflict data 28 is compared against summary status data representing the currently executing processing transactions on other processors to identify if a potential conflict exists. The summary conflict and status data may be inexact in the interests of increased speed and efficiency and accordingly generate some false positive results. However, the summary conflict and status data is provided in a form that does not produce negative results unless the full data would also indicate negative such that if the summary conflict data 28 does not indicate a conflict with the corresponding summary status data for the currently executing processing transactions elsewhere, then no conflict is predicted to exist. Conversely, false positive results can be removed by the further stage in the check whereby the conflict list data 30 is compared with a list of the currently existing processing transactions. This conflict list data can use the more specific transaction identifiers which can be compared with the transaction identifiers of the current existing processing transactions as will be described below.

The conflict data can be subject to processing to remove “stale” conflicts, i.e. remove conflicts which have not arisen for greater than a predetermined time.

Example pseudo code for generating a Conflict Summary Bitmap would
be: for each XactionID in table

conflict Summary Bitmap = 0;
for each Conflict Xaction IDS in list

Conflict Summary Bitmap |=hash(Conflict XactionID);

More efficient schemes can be anticipated (e.g. just update on insertion and only using inserted ID—no need to rerun whole calculation—with the example hash there is no need to repeat the whole calculation on the insertion of a TransactionID into the list, the Conflict Summary Bitmap may just be updated using the newly added TransactionID).

For a 64-bit summary bitmap size an example hash function is:

hash(x)=x % 64;

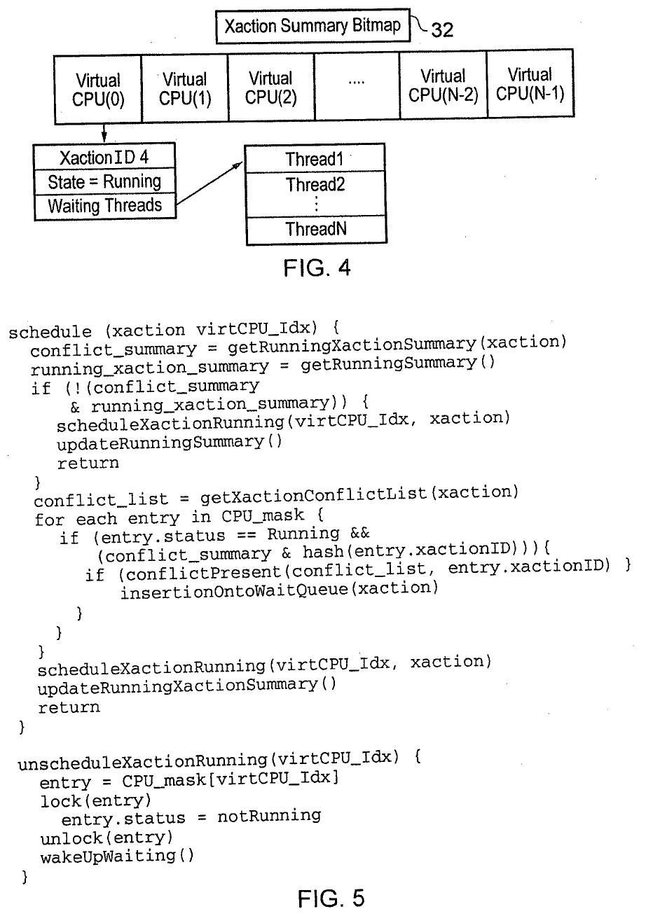

FIG. 4 schematically illustrates the status data indicating which processing transactions are currently executing on the processors 4, 6, 8, 10. This status data tracks all the running threads in the system and what processing transactions they are currently running. Each thread in the user application is given an entry in the data structure of the status data and is called a virtual CPU. Each entry has an attached status entry that tracks what processing transaction is running, if any, by logging the transaction identifier. The entry also tracks if the thread is currently “running” a processing transaction, “aborting” a processing transaction or “not running” a processing transaction (which may mean it is executing regular code which is not divided into processing transactions or has been suspended). Each entry in the status data also includes a list of all threads that are waiting for it to finish (i.e. are pended) due to being predicted as giving rise to a conflicting transaction.

Summary status data 32 is generated by hashing the transaction identifiers for all the running transactions using a hash function equivalent to the hash which generated the summary conflict data 28 discussed previously. In this way, the summary status data 32 can be compared with the summary conflict data 28 of a candidate processing transaction to be executed so as to identify rapidly if a potential conflict exists. This initial comparison of summary conflict data 28 and summary status data 34 can be performed by hardware triggered by a native processing instruction (TMSTART) executing on the processor concerned prior to the processing transaction instructions. This initial check can accordingly be rapid and efficient. If this initial check indicates the potential for a conflict, then the further stage in the check process is performed whereby the conflict list data 30 is compared with the full status data of FIG. 4 under software control, such as under control of the scheduling runtime. This further stage of the checking process should be relatively infrequently invoked as predictions of conflict should be relatively infrequent.

In order to save storage space associated with the conflict data of at least FIG. 3, it is possible to combine the information characterising the conflicts associated with a plurality of processing transactions into one transaction entry 26. This conflict information will then alias upon different processing transactions to those with which it arose and accordingly produce some false positives. The reduction in storage space requirements may nevertheless justify this problem. It is also possible to reduce the information stored in the table in other ways, e.g. by storing only the last N conflicts detected per entry in the table or by storing the N transactions most likely to cause conflicts by tracking the seen conflicts and assigning them confidence values that are updated as the program(s) run. The number of conflicts tracked can be greater than N and/or N can be a value that varies with predicted unlikely-to-conflict transactions being periodically removed. N could vary for each transaction entry to make better use of the storage available.

As an example, N could be a dynamic value, where you would prune the tree of any past conflict that had a low confidence value. Accordingly, using some confidence metric, like a saturating counter that gets incremented every conflict, and decremented using some method, the system can prune away entries when their confidence drops below a certain threshold. This way the system mainly stores high confidence of conflicting transactions, making searching the tree faster. A method to decrement a confidence counter is to summarize its read/write set in a similar way as for summarizing transaction IDs.

That memory footprint summary can then be saved and any blocked transactions waiting on this transaction will then inspect the summary and determine if they would have conflicted (useful serialization, increment confidence) or if they would not have conflicted (unnecessary serialization, decrement confidence).

Example pseudo code for generating Xaction Summary Bitmap
Xaction Summary Bitmap = 0;
for each Virtual CPU in table

Xaction Summary Bitmap |=hash(XactionID);

For a 64-bit summary bitmap size, an example hash function is:

hash(x)=x % 64;

The data structures of FIG. 3 and FIG. 4 as well as the scheduling runtime and operating system of FIG. 2 are used to predict whether a thread trying to schedule a transaction can run in parallel with other concurrently running transactions already in the system. Each time a transaction wants to execute, the code illustrated in the upper portion of FIG. 5 is executed to detect potential conflicts and determine if it can run, or needs to be queued and wait pended for another transaction to finish. When a thread finishes running its transaction, the scheduling runtime can be called again to wake up (reschedule) any threads waiting for it to finish. This can be achieved by the code illustrated in the lower portion of FIG. 5.

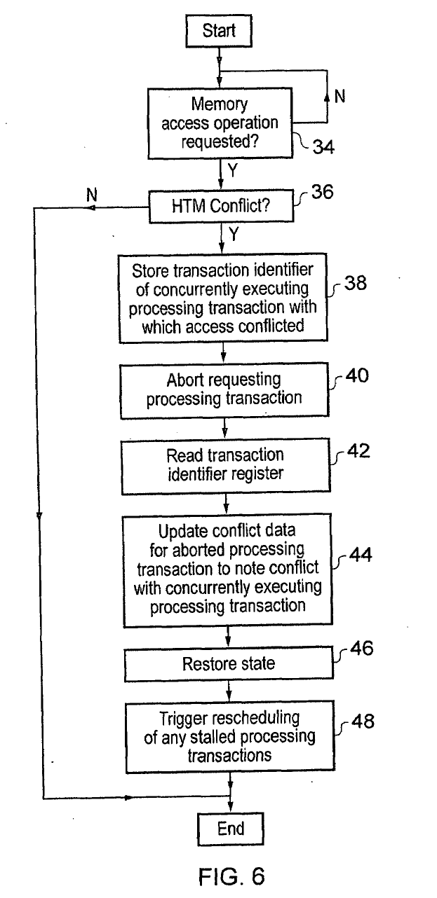

FIG. 6 is a flow diagram illustrating the processing performed when a processing transaction is executing to detect hardware transactional memory conflicts. At step 34 processing waits until a memory access operation is requested in association with a processing transaction. At step 36 the coherency control and hardware transaction memory control circuitry 22 illustrated in FIG. 1 is used to detect any hardware transactional memory conflict. If no such conflict is detected, then this conflict detecting processing finishes and the memory operation requested completes in the normal fashion.

If the determination at step 36 is that a hardware transactional memory conflict has arisen, then processing proceeds to step 38 at which the transaction identifier of the processing transaction which was already running and with which the conflict would occur if the memory access operation was to proceed is returned. This transaction identifier can be stored within a transaction identifier register 24 as illustrated in FIG. 2. The transaction identifier may also be stored within a general purpose register of the processor concerned (i.e. the one in which the conflicting transaction was attempting to run) as this processor will have its activity aborted at step 40 and accordingly its general purpose registers will be available for reuse.

At step 42 the transaction identifier register is read by the scheduling runtime and then at step 44 the conflict data for the aborted processing transaction is updated to note the newly encountered conflict with the concurrently executing processing transaction as indicated by the transaction identifier register content. At step 46 the state of the processor which was attempting to run the aborted processing transaction is restored to the point prior to that aborted processing transaction. The storage of such recovery state within systems employing hardware transactional memories enables the transactions to be aborted and the state rolled back to previously known good state. At step 46 a rescheduling of any stalled processing transactions as indicated by the status data of FIG. 4 is attempted. It may be that none of these stored processing transactions is yet able to be run as they are still blocked by other processing transactions, but it may be that the processing transaction that has just aborted does release some stalled threads or that some other threads have completed their execution and accordingly the reason for stalling those pended threads has been removed.

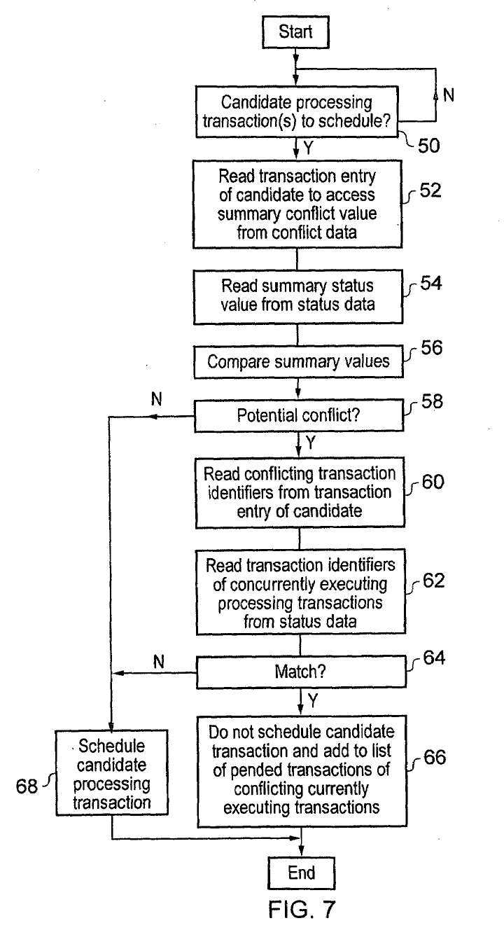

FIG. 7 is a flow diagram illustrating the operation of the scheduling. At step 50 the system waits until a candidate processing transaction or transactions is to be scheduled. It may be that processing transactions are considered in groups with conflicts for any member of that group being identified using the conflict data and used to pend all of the transactions within that group to a later time. This can save overhead associated with the scheduling checks at the loss of some granularity in the control of individual processing transactions.

When a candidate processing transaction requires scheduling as identified at step 50, processing proceeds to step 52 at which the transaction entry for the candidate transaction is read in the form of the summary conflict data value 28. Step 54 then reads the summary status data value 32 characterising the currently executing processing transactions. Step 56 compares the summary data read at steps 52 and 54. If a potential conflict is identified, then step 58 directs processing to step 60. This potential conflict may be a false positive. Step 60 seeks to perform a further stage of checking by reading the conflicting transaction identifiers from the conflict list data 30 of the transaction entry 26. Furthermore, the transaction identifiers associated with each of the virtual CPUs of the status data of FIG. 4 are read at step 62. Step 64 determines whether or not there is a match between this conflict list data and the full status data. If there is a match, then the potential conflict is confirmed and step 66 serves not to schedule the candidate transaction and add it to the list of pended transactions (threads) associated with the currently executing transaction against which a conflict has been noted. This is the list of pended transactions illustrated as Thread1, Thread2 etc in FIG. 4.

If the determination at step 58 or at step 64 was that no conflict has arisen, then step 68 serves to schedule the candidate processing transaction.

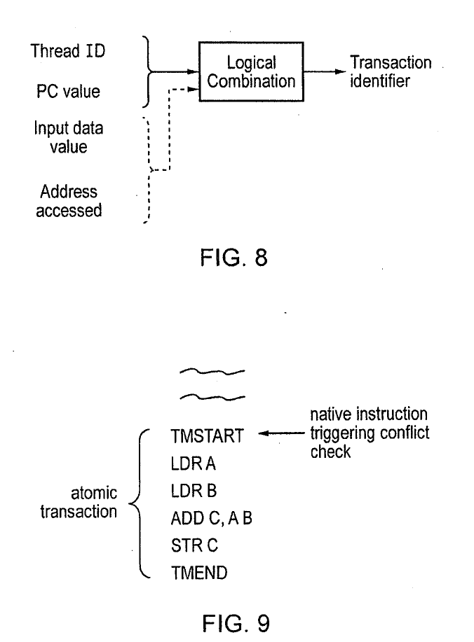

FIG. 8 schematically illustrates how a transaction identifier can be derived. The transaction identifier can be derived by a logical combination, hash or otherwise in dependence upon its associated thread identifier and the program counter value corresponding to the start address of the code containing the processing transaction concerned. The transaction identifier can also additionally, or alternatively, be dependent upon an input data value to the thread or processing transaction concerned and the address within the memory being accessed by the processing transaction. Further ways of increasing the specificity of the transaction identifier are also possible.

FIG. 9 schematically illustrates a code section of four ARM instructions corresponding to an atomic processing transaction. This is the type of processing transaction for which a hardware transactional memory seeks to identify conflicts with other concurrently executing processing transactions in order to facilitate parallel processing. The processing transaction of FIG. 9 is prefixed by a native instruction TMSTART which serves to trigger a conflict checking operation to be performed. This may be the combined hardware and, if necessary, software checking operation previously described. If this check is passed such that no conflict is identified, then the atomic processing transaction will complete. The native instruction TMEND indicates the end of the atomic processing transaction. The programmer or the compiler adds the native program instructions TMSTART and TMEND to the program which is to be parallel executed. The processors 4, 6, 8, 10 are modified to generate signals triggering the conflict check to be performed in response to these native instructions under control of the hardware transaction memory control circuitry 22 and/or the scheduling runtime as previously discussed.

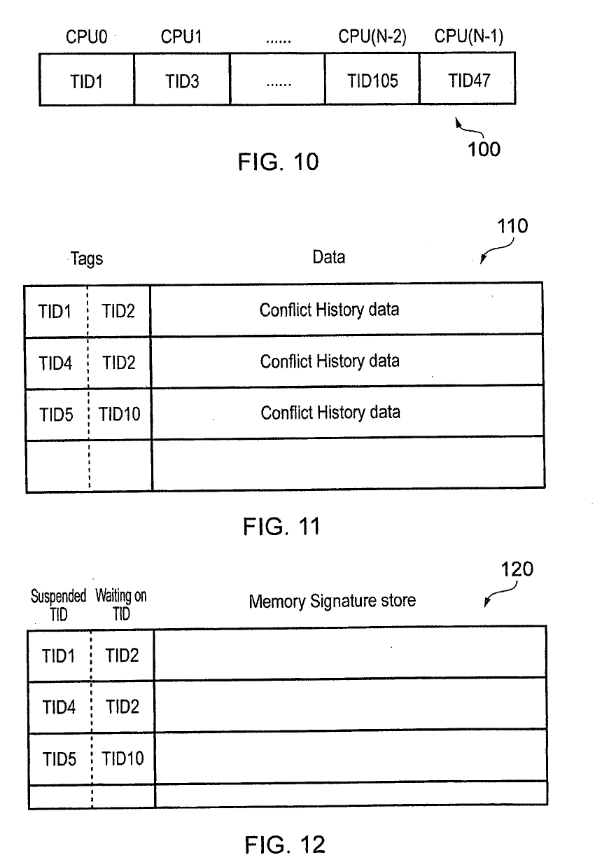

FIG. 10 schematically illustrates tag generating circuitry 100. The tag generating circuitry 100 stores a table of processing transaction identifiers TIDn indicating for each processor (whether physical or logical) within the system which are sharing the transactional memory what is the current processing transaction being executed by that processor. Thus, in the example shown in FIG. 10, there are N processors and the tag generating circuitry 100 stores N processing transaction identifiers TIDs. CPU0 is executing a processing transaction with the processing transaction identifier TID1. CPU1 is executing the processing transaction with processing transaction identifier TID3. Each time a section of code corresponding to a processing transaction to be handled atomically by the transactional memory is encountered by one of the processors, then the processor concerned broadcasts signals (a TID) identifying that processing transaction to the other processors within the system which are sharing the transactional memory. Each processor has associated tag generating circuitry 100 storing the processing transaction identifiers for all of the other processors sharing the transaction memory. The broadcasting of the processing transaction identifiers can be triggered by including appropriate instructions within the program stream being executed by the processors, e.g. a TMSTART instruction and a TMEND instruction may be used at the beginning and end of the code corresponding to a processing transaction and serve to generate signals broadcasting the transaction identifier of a processing transaction being started and the transaction identifier of a processing transaction being completed.

The tag generating circuitry 100 as well as storing the processing transaction identifiers TIDn for each of the other processors within the system is responsive to a tag identifier supplied to it when its own processor starts execution of a processing transaction to generate tag data which can then be used to index into a conflict data cache. In one form the tag data may be generated for each combination of the processing transaction identifier being started by the processor containing the tag generating circuitry 100 concerned with the respective processing transaction identifiers for each of the other processors which are currently executing a processing transaction to the transactional memory. Thus, if the processor containing the tag generating circuitry 100 of FIG. 10 is about to start execution of a processing transaction with a processing transaction Identifier TIDx, then the tag generating circuitry 100 will generate tag data in the form of a concatenation of processing transaction identifiers, i.e. TIDxTID1, TIDxTID3, . . . , TIDxTID105 and TIDxTID47. Thus, in this example embodiment the tag data is a pair of transaction identifiers concatenated together. The tag data could also be formed in other ways, such as a hash of the tag identifiers of the processing transactions executing on the processor in question and the tag identifiers for the other processors within the system or just using the candidate transaction identifier.

The tag data generated by the tag generating circuitry 100 is used to index into a conflict data cache 110 as illustrated in FIG. 11. Tag data will be generated for each pair of processing transactions which would be concurrently executed if the candidate processing transaction for the current processor were allowed to proceed. A check within the conflict data cache 110 is made to see if any conflict between those processing transaction has previously been detected and accordingly predict whether or not a conflict will arise if the candidate processing transaction is allowed to proceed.

The conflict data cache 110 may have a variety of different forms. It may be a fully associative cache memory, a set associative cache memory or a direct mapped cache memory depending upon the particular performance characteristics and other engineering trade offs of the system concerned.

The conflict data cache 110 in this example embodiment is indexed by the tag data generating by the tag generating circuitry 100. Thus, the example illustrated in FIG. 11 shows in the first entry of the cache that a conflict has previously been detected between processing transactions having processing transaction identifiers TID 1 and TID2. Thus, if the current processor in which an attempt is being made to start a processing transaction with the processing transaction identifier TIDE is storing within its tag generating circuitry 100 an indication that another processor is currently executing the processing transaction with a processing transaction identifier TID2, then the tag data generated will be TID1TID2. This tag data will index to and/or hit within the first entry within the conflict data cache 110 and access the prediction data in the form of conflict history data. This conflict history data can take a variety of different forms and it may be that a hit within the conflict data cache will indicate a prediction that a conflict will occur and that the processing transaction with processing transaction identifier TID1 should not be started. However, a more sophisticated approach may store within the conflict history data a count (such as a saturating up/down count) indicating how many times a conflict has previously been detected between those two processing transactions vs how many times those processing transactions have run and had behaviour that has not or would not have resulted in a conflict. If this count exceeds a threshold value, then a prediction of a potential conflict can be made with confidence and it will be more efficient to suspend execution of the processing transaction with the processing transaction identifier TID1.

In one example embodiment, when a processing transaction ends it broadcasts this to other processors together with a compressed log of addresses accessed by that transaction. This log can then be compared with a similar log maintained for the candidate transaction. When the candidate transaction completes, the logs can be compared; if this comparison indicates that there wouldn't have been a conflict between the two transactions, then the count in the record linking these transactions as conflicting can be reduced.

The way the up/down counter works can be similar to those used in branch prediction and the like, e.g. a positive value indicates a predicted as likely outcome, a negative value indicates a predicted as not likely outcome. One reason you need saturating behaviour is to stop the counter from wrapping round the implemented range and the prediction swinging in polarity.

Other methods to reduce the count are to decrement it after some period of time has elapsed (perhaps by more than just one—reset for instance). This approach will make the predictor re-evaluate it's position periodically, and allow the predictor to adapt to changing conflict behaviours.

FIG. 12 illustrates suspended processing transaction circuitry 120 which stores data identifying for each suspended candidate processing transaction a currently executing processing transaction with which at least one of a conflict was detected or a potential conflict was detected. Thus, the first entry in FIG. 12 indicates that the processing transaction TID1 was attempted to be scheduled and was suspended due to a predicted conflict (or detected conflict) with what was at the time a currently already executing processing transaction TID2. Associated with the entry within the suspended transaction processing circuitry a count value as discussed above and a memory signature store used to store data identifying which memory locations were actually accessed by the currently executing processing transaction TID2 such that when the suspended processing transaction is actually executed then a determination can be made as to whether or not a conflict would in practice have occurred and the conflict history data accordingly updated to be more accurate.

As previously mentioned, when a processor completes execution of a processing transaction in the transactional memory, it will broadcast a signal to the other processors identifying the processing transaction which has now completed execution. This broadcast transaction end signal can be looked up within the suspended transaction processing circuitry 120 in order to identify if there are any suspended processing transactions waiting for the processing transaction which has just finished to complete before they are started. If any such suspended processing transactions are identified, then, in this example embodiment, an interrupt can be generated to the operating system to trigger scheduling of the suspended processing transaction and the entry within the suspended transaction processing circuitry may be removed. (It is also possible that in other embodiments a hardware-only mechanism could be used to wake-up suspended processing transactions). If the completion of a processing transaction unblocks several suspended processing transactions such that they are now permitted to execute, then the triggering of these multiple suspended processing transactions may be combined into the action of a single interrupt to the operating system in order to improve efficiency. Thus, a single interrupt will identify multiple suspended processing transactions which can now be scheduled. Alternatively, the operating system may be triggered from a timed interrupt to periodically examine the suspended processing transactions and restart any that are now unblocked.

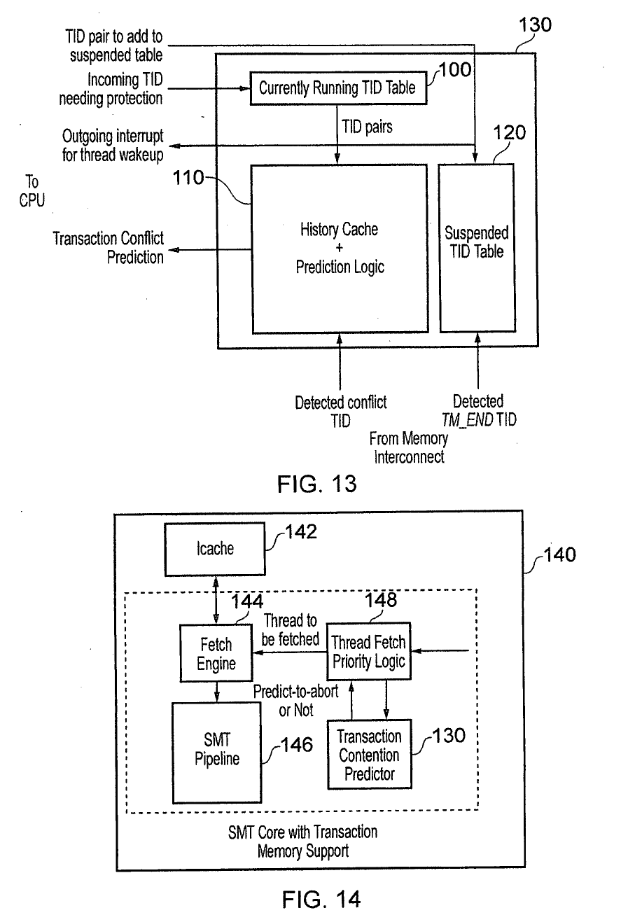

FIG. 13 illustrates a transaction conflict predictor containing tag generating circuitry 100, a conflict data cache 110 and suspended transaction processing circuitry 120. In operation the processing transaction identifier for a processing transaction which is a candidate for starting on the processor within which the transaction conflict predictor 130 is provided is supplied to the tag generating circuitry 100. This serves to generate a set of transaction processing identifier pairs which are passed to the conflict data cache 110 and for which it is determined whether or not a hit occurs within the conflict data cache 110. If a hit occurs, then this indicates that the conflict data cache 110 is storing conflict history data indicative of a previously detected conflict between those two processing transactions. This prediction data is used to confirm the conflict is to be predicted and, if so, triggers, in this example embodiment, generation of an interrupt to operating system software which can then respond by interpreting the conflict history data and, if necessary, suspending the scheduling of the candidate processing transaction whose processing transaction identifier was input to the tag generating circuitry 100.

In other embodiments there is no immediate call to software in order to suspend the candidate thread/transaction. For example if the processor system is a multithreaded (MT) processor, then the candidate thread may be suspended by recording the fact that this is the case within a suspended TID table. The MT processor can be responsive to the data in the suspended TID table to suspend that thread with no software involvement. In a similar manner, in a multiprocessor (MP) system the processor executing the candidate thread may stall in response to the detected/predicted conflict instead of interrupting to the OS.

The motivations for not calling into the OS include that in the time it takes to call the OS the currently executing transaction that caused the predicted conflict may have completed. A hardware approach may therefore be able to reschedule the candidate thread for execution with no call to the software. Alternatively or in addition, the hardware may have alternative work it can select to do (without software intervention), e.g. an MT processor may have a plurality of threads that it can select from.

A call (interrupt) to software, such as the OS, is one option. However, instead of calling immediately through an interrupt it is possible to allow the software to discover that a thread has been descheduled by the hardware at the next time that the OS interrupts the processor to do a context switch. In this scenario the OS can have set up a periodic timer to preempt the running thread and allow the OS to schedule a different process. At this point the OS can examine the suspended transaction table (or other state) and determine that the thread that was running had been suspended due to a hardware prediction of conflict. The OS may then make it's own decision not to attempt to reschedule that thread until a later point (e.g. an indication from the hardware that the other transaction had finished).

When a candidate processing transaction is suspended by the operating system, the operating system generates data identifying the suspended processing transaction and the processing transaction upon which the suspended processing transaction is waiting for completion and outputs this to the suspended processing transaction circuitry 120 where it forms one of the entries. These entries can alternatively be made by the hardware. The operating system may also have direct access and management rights over the data stored elsewhere in the conflict detection/prediction hardware. The operating system can then set this data or read this data during a task switch. The suspended processing transaction circuitry 120 also receives broadcast signals indicating the finishing of processing transactions executed by other processors and these are used to look up within the suspended processing transaction circuitry 120 whether or not there are any suspended processing transactions waiting for the completion of those now completed processing transactions that were being executed in different processors. If any such now unblocked suspended processing transactions are identified, then the suspended transaction processing circuitry 120 generates an interrupt to the operating system to trigger the rescheduling of the suspended processing transaction. If several suspended processing transactions are unblocked together, then the triggering of their rescheduling can be concatenated and performed via a single interrupt passing appropriate data identifying the multiple different suspended processing transactions.

When a conflict is detected between two executing processing transactions, this generates a detected conflict signal which is input to the conflict data cache 110 and causes an entry to be made therein. This entry includes tag data identifying the two processing transactions concerned as well as conflict history data indicating a count of how many times that conflict has arisen. When the entry is first made this count can be set to one. When subsequent conflicts between the two processing transactions concerned are detected, a new entry is not made rather the up/down count value for the existing entry is increased up to a saturating count value. A high count value will indicate a strong prediction that a conflict will arise if those two processing transactions are scheduled for execution at the same time. The count value may be decreased by one or more of the previously described mechanisms.

At an overall level, the transaction conflict predictor 130 is responsive to broadcast signals indicating the start of a processing transaction within another processor to note the processing transaction as currently executing. When the processor wishes to start its own processing transaction then tag data comprising pairs of transaction identifiers formed of the candidate processing transaction identifier and each of the currently executing processing transactions on other processors are formed and used to index into the conflict data cache 110. If a hit occurs, then prediction data is read from the conflict data cache 110 and a prediction of whether or not a conflict will arise is made by the hardware (or in some embodiments the operating system) and, if necessary, the candidate processing transaction is suspended. It is also possible that the operating system may take account of the relative priorities of the two processing transactions between which a potential conflict has been identified. If the candidate processing transaction is of a sufficiently higher priority than the currently executing processing transaction, then it may be more desirable to stop the execution of the currently executing processing transactions so as to permit the candidate processing transaction to start execution. This would not normally be the case as the work performed in the partial execution of the now cancelled processing transaction would be lost, but if the priority associated with the candidate processing transaction is high enough, then this may be justified. Such a determination as to which processing transaction should be scheduled or suspended and whether or not the prediction is of sufficient confidence that any action should be taken at all, may be made by software within the operating system. The detection of conflicts should be sufficiently rare that the performance lost by requiring such processing to be performed in software by the operating system is more than compensated by avoiding the need to provide special purpose hardware to make such complex decisions. The hardware that is provided in the form of the transaction conflict predictor 130 is able to safely identify the common case which is that no conflict will arise and allow normal scheduling to proceed in these circumstances without requiring the intervention of the operating system in order to manage conflict.

When a processing transaction ends, a signal indicating this is broadcast through the system and updates the tag generating circuitry 100 and the suspended transaction processing circuitry 120. The tag generating circuitry 100 removes the indication that the now ended processing transaction is running from its table. The suspended transaction processing circuitry 120 triggers the waking up of any suspended processing transactions which had been suspended due to a detected or potential conflict with the now ended processing transaction.

FIG. 14 illustrates a simultaneous multithreading processor 140 including an instruction cache 142, a fetch engine 144 and an execution pipeline 146. Thread fetch priority logic 148 controls the fetch engine 144 in a manner that selects for which processing transaction instructions are fetched for execution by the execution pipeline 146. Such multithreading processors 140 can interleave the execution of program instructions for different processing transactions, such as by alternating execution of individual instructions between two processing transactions (threads) to a transactional memory.

In the embodiment illustrated in FIG. 14, a transaction conflict predictor 130 as previously described is added to the processor 140. This transaction conflict predictor generates a signal indicative of whether or not a conflict will occur with another processing transaction currently being executed by the processor 140 if a newly encountered candidate processing transaction is scheduled. If a conflict is predicted, then the prediction generated by the transaction conflict predictor 130 serves to inhibit the fetch priority logic 148 from directing the fetch engine 144 to fetch instructions for that candidate processing transaction. The thread fetch priority logic 148 can instead control the fetch engine 144 to fetch program instructions corresponding to a different processing transaction with which a conflict is not predicted. It will be appreciated that the processor 140 illustrated in FIG. 14 provides multiple logical processors executing respective processing transactions and between which the conflict data of the current technique may be used to predict conflicts and control scheduling in a manner seeking to improve overall efficiency.

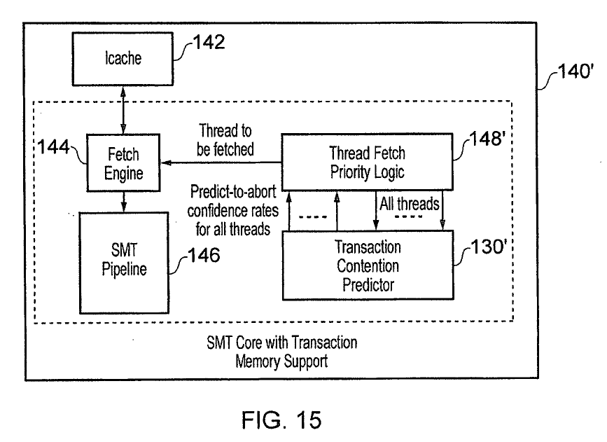

FIG. 15 illustrates a second embodiment of a simultaneous multithreading processor 140′. In this second example embodiment, the thread fetch priority logic 148′ and the transaction conflict predictor 130′ have been modified. The thread fetch priority logic 148′ provides multiple signals to the transaction conflict predictor 130′ indicating all of the processing transactions which are candidates for scheduling. The transaction conflict predictor 130′ returns multiple signals indicating the relative confidence of a prediction that a conflict either will or will not occur if the particular candidate processing transactions is scheduled given the currently executing processing transactions. In this way, the fetch engine 144 can be directed to fetch program instructions for the processing transaction identified by the thread fetch priority logic 148′ as having an appropriate combination of a high priority for execution and a low likelihood of a conflict arising.

The examples illustrated in FIGS. 14 and 15 show the fetching of instructions by the fetch engine 144 from the instruction cache 142 as being controlled so as to control the scheduling of the associated processing transactions. In other embodiments it would also be possible to instead control the issuing of instructions into the execution pipeline 146 with program instructions for suspended processing transactions being fetched and held ready for issue by not actually issued until the processing transaction with which a conflict has predicted is completed its execution.

Returning to the conflict data cache 110 illustrated in FIG. 11, this has been shown as indexed by pairs of transaction identifiers and storing conflict history data for that particular pair of processing transactions. In other embodiments it would be possible to have each entry within the conflict data cache 110 correspond to a particular candidate processing transaction and the conflict history data within that entry indicate a number of the other processing transactions with which a conflict has previously been detected for that candidate processing transaction. In these embodiments each entry stores global conflict data identifying in respect of a candidate processing transaction at least some other processing transaction with which a conflict has previously been detected. This global conflict data may include count values and the like indicating the relative likelihoods of the individual conflicts.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

We claim:

1. A method of processing data using a plurality of processors and a transactional memory, said method comprising the steps of:
detecting with said transactional memory conflict arising between concurrent processing transactions executed by respective processors accessing shared data within said transactional memory;
in response to said conflicts, storing conflict data for respective processing transactions indicative of with which other processing transactions a conflict has previously been detected; and
scheduling processing transactions to be executed in dependence upon said conflict data.

2. A method as claimed in claim 1, wherein, upon detecting a conflict, said transactional memory provides a transaction identifier indicative of a processing transaction with which said conflict has arisen.

3. A method as claimed in claim 2, wherein said transactional memory stores said transaction identifier within at least one of:
a dedicated transaction identifier register;
a general purpose register within a register bank; and
a memory location.

4. A method as claimed in claim 2, wherein said transaction identifier is read and used by conflict software to form said conflict data.

5. A method as claimed in claim 1, wherein said scheduling is at least partially performed by scheduling software responsive to said conflict data.

6. A method as claimed in claim 1, wherein said scheduling is at least partially performed by scheduling hardware responsive to said conflict data.

7. A method as claimed in claim 1, wherein said conflict data comprises a plurality of transaction entries, each transaction entry corresponding to a processing transactions and at least some of said transaction entries storing data at least indicative of one or more processing transactions with which said processing transaction has previously conflicted.

8. A method as claimed in claim 7, wherein each transaction entry includes a summary conflict entry indicative of said one or more processing transactions with which said processing transaction of that transaction entry has previously conflicted and said scheduling includes comparing a summary conflict entry for a candidate processing transaction with corresponding summary status data indicative of currently executing processing transactions so as to identify a potential conflict.

9. A method as claimed in claim 8, wherein each transaction entry includes a conflict list having respective entries for each of said one or more processing transactions with which said processing transaction has previously conflicted and, after a match with said summary conflict entry of a matching transaction entry, said scheduling includes comparing a conflict list for said matching transaction entry with said currently executing processing transactions so as to confirm a potential conflict.

10. A method as claimed in claim 1, wherein said conflict data comprises a plurality of transaction entries, each transaction entry corresponding to a plurality processing transactions and storing data at least indicative of one or more processing transactions with which any of said plurality of processing transaction has previously conflicted.

11. A method as claimed in claim 1, comprising storing status data indicative of which processing transactions are currently executing upon said plurality of processors.

12. A method as claimed in claim 11, wherein said scheduling includes comparing said status data with said conflict data of a candidate processing transaction to identify if any of said currently executing processing transactions have previously conflicted with said candidate processing transaction.

13. A method as claimed in claim 11, wherein said status data includes a summary status entry indicative of which processing transactions are currently executing upon said plurality of processors.

14. A method as claimed in claim 1, wherein said conflict data comprises a transaction identifier formed in dependence upon a thread identifier associated with a processing transaction giving rise to a conflict and a program counter value corresponding to a starting program address of said processing transaction giving rise to said conflict.

15. A method as claimed in claim 14, wherein said transaction identifier is formed in dependence upon one or more of:
at least one input data value to said processing transaction giving rise to said conflict; and
at least one memory address value accessed by said processing transaction giving rise to said conflict.

16. A method as claimed in claim 1, wherein said transactional memory is a hardware transactional memory including at least some support circuitry supporting a transactional memory model of operation.

17. A method as claimed in claim 1, wherein each of said processors is responsive to a native program instruction to trigger a check using said conflict data for a potential conflict with any currently executing processing transaction.

18. A method as claimed in claim 17, wherein said check comprises:
an initial stage performed under hardware control and comparing summary data to identify if no conflict is predicted; and
a further stage performed under software control if said initial stage does not identify that no conflict is predicted to confirm whether a conflict is predicted.

19. A method as claimed in claim 1, wherein, when a conflict is identified, a call is made to at least one of an operating system and scheduling software to trigger attempted rescheduling of processing transactions for which said conflict data previously indicated a potential conflict.

20. A method as claimed in claim 1, wherein processing to be performed is divided in to a plurality of processing threads, at least one of said processing threads comprising one or more processing transactions, and at least one of an operating system and scheduling software access data characterising one or more of:
which threads exist to be scheduled;
which threads are currently running;
which threads are waiting to be scheduled; and
which threads cannot currently be scheduled due to a potential conflict indicated by said conflict data.

21. A method as claimed in claim 1, wherein when an executing processing transaction completes, a search operation is performed to identify any blocked processing transactions that were being prevented from being scheduled as said conflict data indicated a potential conflict with said executing processing transaction, any identified blocked processing transaction then being released so as to be eligible for scheduling.

22. A method as claimed in claim 1, wherein an operating system controls issue to one of said plurality of processors of processing threads marked as active processing threads and does not issue processing threads marked pended processing threads, scheduling software responsive to said conflict data serving to update marking of processing threads as either active processing threads or pended processing threads.

23. A method as claimed in claim 22, wherein when a conflict arises during execution of a processing transaction that is then aborted, said scheduling software calls said operating system to mark said processing thread including said processing transaction that was aborted as a pended processing thread.

24. A method as claimed in claim 23, wherein, followed marking of said processing transaction that was aborted as a pended processing thread, said operating system searches for a processing thread to issue in place of said pended processing thread.

25. A method as claimed in claim 1, wherein said plurality of processors comprise a plurality of logical processors provided by a multithreading processor supporting multithreading that interleaves execution of program instructions corresponding to different concurrent processing threads.

26. A method as claimed in claim 25, wherein said multithreading processor is a simultaneous multithreading processor.

27. A method as claimed in claim 25, wherein said step of scheduling comprises selecting for which of a plurality of processing transactions program instructions are fetched from memory for execution by said multithreading processor.

28. A method as claimed in claim 27, wherein said step of scheduling suppresses fetching of program instructions for a processing transaction for which said conflict data indicates a conflict has previously occurred with an already executing processing transaction.

29. A method as claimed in claim 27, wherein said step of scheduling selects a candidate processing transaction for which program instructions are to be fetched and blocks fetching for said candidate processing transaction if said conflict data indicates a conflict has previously occurred with an already executing processing transaction.

30. A method as claimed in claim 29, wherein if fetching for said candidate processing transaction is blocked, then said step of scheduling selects a different processing transaction from said plurality of processing transactions as said candidate processing transaction.

31. A method as claimed in claim 27, wherein said step of scheduling detects using said conflict data for a plurality of candidate processing transactions respective likelihoods of a conflict arising with a currently executing processing transaction and selects program instructions of a processing transaction for fetching in dependence upon said likelihoods.

32. A method as claimed in claim 31, wherein step of selecting is also dependent upon respective priority levels associated with said plurality of candidate processing transactions.

33. A method as claimed in claim 27, wherein said step of scheduling is dependent upon respective priority levels of a candidate processing transaction and a currently executing processing transaction with which a conflict has previously been detected such that if said candidate processing transaction has a priority sufficiently greater than said currently executing processing transaction, then execution of said currently executing transaction is stopped such that said candidate processing transaction can be executed.

34. A method as claimed in claim 1, wherein said conflict data is used to identify when a suspended processing transaction that conflicted with another processing transaction can be rescheduled as said another processing transaction has completed.

35. A method as claimed in claim 1, wherein said transactional memory comprises a conflict data cache memory storing at least a portion of said conflict data indicative of previously detected conflicts between processing transactions.

36. A method as claimed in claim 35, wherein each entry in said conflict data cache corresponding to a pair of processing transaction between which a conflict has previously been detected.

37. A method as claimed in claim 36, wherein entries within said conflict data cache have a tag indicative of a pair of processing transactions between which a conflict has previously been detected.

38. A method as claimed in claim 36, wherein each entry within said conflict data cache corresponds to a previously detected conflict between a pair of processing transactions and stores a count value indicative of a predicted likelihood of conflict occurring.

39. A method as claimed in claim 35, wherein said conflict data stored within conflict data cache identifies processing transaction one of:
(i) uniquely using a transaction identifier; or
(ii) non-uniquely using a hash value derived from a transaction identifier.

40. A method as claimed in claim 38, wherein tag generating circuitry stores data indicative of currently executing processing transactions and is responsive to an identifier for a candidate processing transaction to be scheduled to generate tag data in respect of a plurality of combinations of said candidate processing transaction and a currently executing processing transaction, said tag data being supplied to said conflict data cache to look up if any conflict has previously been detected between said candidate processing transaction and any of said currently executing processing transactions.

41. A method as claimed in claim 40, wherein said tag generating circuitry stores a table of transaction identifiers identifying said currently executing processing transactions.

42. A method as claimed in claim 40, wherein said tag data is a pair of transaction identifiers.

43. A method as claimed in claim 35, wherein said conflict data cache is one of:
(i) fully associative;
(ii) set associative; or
(iii) direct mapped; and
Said conflict data cache is searched using data identifying at least a candidate processing transaction to be scheduled.

44. A method as claimed in claim 40, wherein said conflict data cache is indexed with said tag data.

45. A method as claimed in claim 35, wherein if a hit occurs in said conflict data cache, then corresponding prediction data is read from conflict data cache to control said scheduling of said candidate processing transaction.

46. A method as claimed in claim 45, wherein said prediction data is indicative of how many conflicts between said processing transaction have previously been detected.

47. A method as claimed in claim 46, wherein said prediction data is a saturating counter.

48. A method as claimed in claim 35, wherein when a hit occurs within said conflict data cache the scheduling of a candidate processing transaction is suspended.

49. A method as claimed in claim 36, wherein scheduling of a candidate processing transaction is suspended by issuing an interrupt to an operating system.

50. A method as claimed in claim 40, wherein said tag generating circuitry is responsive to transaction identifying signals received from said plurality of processors indicative which processing transactions are currently being executed.

51. A method as claimed in claim 1, wherein suspended processing transaction circuitry stores data identifying candidate processing transactions not scheduled due to at least one of a detected conflict and a detected potential conflict.

52. A method as claimed in claim 51, wherein said suspended transaction processing circuitry stores data identifying for each suspended candidate processing transaction a currently executing processing transaction with which at least one of a conflict was detected or a potential conflict was detected.

53. A method as claimed in claim 52, wherein said suspended transaction processing circuitry is responsive to signals received from said plurality of processors indicative of processing transactions that have finished execution to trigger scheduling of any suspended candidate processing transaction suspended in response to a detected potential conflict with a processing transaction that has now finished execution and removal of a corresponding entry within said suspended transaction processing circuitry.

54. A method as claimed in claim 1, wherein said plurality of processor broadcast signals indicative of a start of a processing transaction and an end of a processing transaction.

55. A method as claimed in claim 54, wherein said scheduling of suspended candidate processing transactions is performed by issuing an interrupt to an operating system.

56. A method as claimed in claim 53, wherein said plurality of processor are logical processors provided by a multithreaded processor.

57. A method as claimed in claim 56, wherein a suspended processing thread is scheduled by a change of a hardware state signal that permits said suspended processing thread to be one of fetched or issued.

58. A method as claimed in claim 55, wherein said suspended processing transaction circuitry combines triggering scheduling of a plurality of suspended candidate processing transactions using a shared interrupt to said operating system.

59. A method as claimed in claim 35, wherein said conflict data cache contains entries each storing global conflict data identifying in respect of a candidate processing transaction any other processing transactions with which a conflict has previously been detected.

60. Apparatus for processing data comprising:
a plurality of processors;
a transactional memory configured to detect conflict arising between concurrent processing transactions executed by respective processors accessing shared data within said transactional memory;
a conflict data store responsive to said conflicts to store conflict data for respective processing transactions indicative of with which other processing transactions a conflict has previously been detected; and
scheduling circuitry responsive to said conflict data to schedule processing transactions to be executed.

61. Apparatus as claimed in claim 60, wherein, upon detecting a conflict, said transactional memory provides a transaction identifier indicative of a processing transaction with which said conflict has arisen.

62. Apparatus as claimed in claim 61, comprising at least one of:
a dedicated transaction identifier register;
a general purpose register within a register bank; and
a memory location
to which said transactional memory stores said transaction identifier.

63. Apparatus as claimed in claim 61, wherein said transaction identifier is read and used by conflict software to form said conflict data.

64. Apparatus as claimed in claim 60, wherein said scheduling circuitry is at least partially controlled by scheduling software responsive to said conflict data.

65. Apparatus as claimed in claim 60, wherein said scheduling circuitry is at least partially performed by dedicated scheduling hardware responsive to said conflict data.

66. Apparatus as claimed in claim 60, wherein said conflict data comprises a plurality of transaction entries, each transaction entry corresponding to a processing transactions and at least some of said transaction entries storing data at least indicative of one or more processing transactions with which said processing transaction has previously conflicted.

67. Apparatus as claimed in claim 66, wherein each transaction entry includes a summary conflict entry indicative of said one or more processing transactions with which said processing transaction of that transaction entry has previously conflicted and said scheduling includes comparing a summary conflict entry for a candidate processing transaction with corresponding summary status data indicative of currently executing processing transactions so as to identify a potential conflict.

68. Apparatus as claimed in claim 67, wherein each transaction entry includes a conflict list having respective entries for each of said one or more processing transactions with which said processing transaction has previously conflicted and, after a match with said summary conflict entry of a matching transaction entry, said scheduling includes comparing a conflict list for said matching transaction entry with said currently executing processing transactions so as to identify a potential conflict.

69. Apparatus as claimed in claim 60, wherein said conflict data comprises a plurality of transaction entries, each transaction entry corresponding to a plurality processing transactions and storing data at least indicative of one or more processing transactions with which any of said plurality of processing transaction has previously conflicted.

70. Apparatus as claimed in claim 60, comprising a status data store for storing status data indicative of which processing transactions are currently executing upon said plurality of processors.

71. Apparatus as claimed in claim 70, wherein said scheduling circuitry compares said status data with said conflict data of a candidate processing transaction to identify if any of said currently executing processing transactions have previously conflicted with said candidate processing transaction.

72. Apparatus as claimed in claim 70, wherein said status data includes a summary status entry indicative of which processing transactions are currently executing upon said plurality of processors.

73. Apparatus as claimed in claim 60, wherein said conflict data comprises a transaction identifier formed in dependence upon a thread identifier associated with a processing transaction giving rise to a conflict and a program counter value corresponding to a starting program address of said processing transaction giving rise to said conflict.

74. Apparatus as claimed in claim 73, wherein said transaction identifier is formed in dependence upon one or more of:
at least one input data value to said processing transaction giving rise to said conflict; and
at least one memory address value accessed by said processing transaction giving rise to said conflict.

75. Apparatus as claimed in claim 60, wherein said transactional memory is a hardware transactional memory including at least some support circuitry supporting a transactional memory model of operation.

76. Apparatus as claimed in claim 60, wherein each of said processors is responsive to a native program instruction to trigger a check using said conflict data for a potential conflict with any currently executing processing transaction.

77. Apparatus as claimed in claim 76, wherein said check comprises:
an initial stage performed under hardware control and comparing summary data to identify if no conflict is predicted; and
a further stage performed under software control if said initial stage does not identify that no conflict is predicted to confirm whether a conflict is predicted.

78. Apparatus as claimed in claim 60, wherein, when a conflict is identified, a call is made to at least one of an operating system and scheduling software to trigger attempted rescheduling of processing transactions for which said conflict data previously indicated a potential conflict.

79. Apparatus as claimed in claim 60, wherein processing to be performed is divided in to a plurality of processing threads, at least one of said processing threads comprising one or more processing transactions, and at least one of an operating system and scheduling software access data characterising one or more of:
which threads exist to be scheduled;
which threads are currently running;
which threads are waiting to be scheduled; and
which threads cannot currently be scheduled due to a potential conflict indicated by said conflict data.

80. Apparatus as claimed in claim 60, wherein when an executing processing transaction completes, a search operation is performed to identify any blocked processing transactions that were being prevented from being scheduled as said conflict data indicated a potential conflict with said executing processing transaction, any identified blocked processing transaction then being released so as to be eligible for scheduling.

81. Apparatus as claimed in claim 60, wherein an operating system controls issue to one of said plurality of processors of processing threads marked as active processing threads and does not issue processing threads marked pended processing threads, scheduling software responsive to said conflict data serving update marking of processing threads as either active processing threads or pended processing threads.

82. Apparatus as claimed in claim 81, wherein when a conflict arises during execution of a processing transaction that is then aborted, said scheduling software calls said operating system to mark said processing thread including said processing transaction that was aborted as a pended processing thread.

83. Apparatus as claimed in claim 82, wherein, followed marking of said processing transaction that was aborted as a pended processing thread, said operating system searches for a processing thread to issue in place of said pended processing thread.

84. Apparatus as claimed in claim 60, wherein said plurality of processors comprise a plurality of logical processors provided by a multithreading processor supporting multithreading that interleaves execution of program instructions corresponding to different concurrent processing threads.

85. Apparatus as claimed in claim 84, wherein said multithreading processor is a simultaneous multithreading processor.

86. Apparatus as claimed in claim 84, wherein said step of scheduling circuitry selects for which of a plurality of processing transactions program instructions are fetched from memory for execution by said multithreading processor.

87. Apparatus as claimed in claim 84, wherein said scheduling circuitry selects from which of a plurality of transactions program instructions are issued for execution by said multithreading processor.

88. Apparatus as claimed in claim 86, wherein said scheduling circuitry suppresses fetching of program instructions for a processing transaction for which said conflict data indicates a conflict has previously occurred with an already executing processing transaction.

89. Apparatus as claimed in claim 86, wherein said scheduling circuitry selects a candidate processing transaction for which program instructions are to be fetched and blocks fetching for said candidate processing transaction if said conflict data indicates a conflict has previously occurred with an already executing processing transaction.

90. Apparatus as claimed in claim 89, wherein if fetching for said candidate processing transaction is blocked, then said scheduling circuitry selects a different processing transaction from said plurality of processing transactions as said candidate processing transaction.

91. Apparatus as claimed in claim 86, wherein said scheduling circuitry detects using said conflict data for a plurality of candidate processing transactions respective likelihoods of a conflict arising with a currently executing processing transaction and selects program instructions of a processing transaction for fetching in dependence upon said likelihoods.

92. Apparatus as claimed in claim 91, wherein selecting is also dependent upon respective priority levels associated with said plurality of candidate processing transactions.

93. Apparatus as claimed in claim 86, wherein said scheduling circuitry schedules in dependence upon respective priority levels of a candidate processing transaction and a currently executing processing transaction with which a conflict has previously been detected such that if said candidate processing transaction has a priority sufficiently greater than said currently executing processing transaction, then execution of said currently executing transaction is stopped such that said candidate processing transaction can be executed.

94. Apparatus as claimed in claim 60, wherein said conflict data is used to identify when a suspended processing transaction that conflicted with another processing transaction can be rescheduled as said another processing transaction has completed.

95. Apparatus as claimed in claim 60, wherein said transactional memory comprises a conflict data cache memory storing at least a portion of said conflict data indicative of previously detected conflicts between processing transactions.

96. Apparatus as claims in claimed 95, wherein each entry in said conflict data cache corresponding to a pair of processing transaction between which a conflict has previously been detected.

97. Apparatus as claimed in claim 96, wherein entries within said conflict data cache have a tag indicative of a pair of processing transactions between which a conflict has previously been detected.

98. Apparatus as claimed in claim 96, wherein each entry within said conflict data cache corresponds to a previously detected conflict between a pair of processing transactions and stores a count value indicative of a predicted likelihood of conflict occurring.

99. Apparatus as claimed in claim 95, wherein said conflict data stored within conflict data cache identifies processing transaction one of:
(i) uniquely using a transaction identifier; or
(ii) non-uniquely using a hash value derived from a transaction identifier.

100. Apparatus as claimed in claim 98, wherein tag generating circuitry stores data indicative of currently executing processing transactions and is responsive to an identifier for a candidate processing transaction to be scheduled to generate tag data in respect of a plurality of combinations of said candidate processing transaction and a currently executing processing transaction, said tag data being supplied to said conflict data cache to look up if any conflict has previously been detected between said candidate processing transaction and any of said currently executing processing transactions.

101. Apparatus as claimed in claim 100, wherein said tag generating circuitry stores a table of transaction identifiers identifying said currently executing processing transactions.

102. Apparatus as claimed in claim 100, wherein said tag data is a pair of transaction identifiers.

103. Apparatus as claimed in claim 95, wherein said conflict data cache is one of:
(i) fully associative;
(ii) set associative; or
(iii) direct mapped; and
said conflict data cache is searched using data identifying at least a candidate processing transaction to be scheduled.

104. Apparatus as claimed in claim 90, wherein said conflict data cache is indexed with said tag data.

105. Apparatus as claimed in claim 95, wherein if a hit occurs in said conflict data cache, then corresponding prediction data is read from conflict data cache to control said scheduling of said candidate processing transaction.

106. Apparatus as claimed in claim 105, wherein said prediction data is indicative of how many conflicts between said processing transaction have previously been detected.

107. Apparatus as claimed in claim 106, wherein said prediction data is a saturating counter.

108. Apparatus as claimed in claim 95, wherein when a hit occurs within said conflict data cache the scheduling of a candidate processing transaction is suspended.

109. Apparatus as claimed in claim 95, wherein scheduling of a candidate processing transaction is suspended by issuing an interrupt to an operating system.

110. Apparatus as claimed in claim 100, wherein said tag generating circuitry is responsive to transaction identifying signals received from said plurality of processors indicative which processing transactions are currently being executed.

111. Apparatus as claimed in claim 60, wherein suspended processing transaction circuitry stores data identifying candidate processing transactions not scheduled due to at least one of a detected conflict and a detected potential conflict.

112. Apparatus as claimed in claim 111, wherein said suspended transaction processing circuitry stores data identifying for each suspended candidate processing transaction a currently executing processing transaction with which at least one of a conflict was detected or a potential conflict was detected.

113. Apparatus as claimed in claim 112, wherein said suspended transaction processing circuitry is responsive to signals received from said plurality of processors indicative of processing transactions that have finished execution to trigger scheduling of any suspended candidate processing transaction suspended in response to a detected potential conflict with a processing transaction that has now finished execution and removal of a corresponding entry within said suspended transaction processing circuitry.

114. Apparatus as claimed in claim 60, wherein said plurality of processor broadcast signals indicative of a start of a processing transaction and an end of a processing transaction.

115. Apparatus as claimed in claim 114, wherein said scheduling of suspended candidate processing transactions is performed by issuing an interrupt to an operating system.

116. Apparatus as claimed in claim 113, wherein said plurality of processor are logical processors provided by a multithreaded processor.

117. Apparatus as claimed in claim 116, wherein a suspended processing thread is scheduled by a change of a hardware state signal that permits said suspended processing thread to be one of fetched or issued.

118. Apparatus as claimed in claim 115, wherein said suspended processing transaction circuitry combines triggering scheduling of a plurality of suspended candidate processing transactions using a shared interrupt to said operating system.

119. Apparatus as claimed in claim 95, wherein said conflict data cache contains entries each storing global conflict data identifying in respect of a candidate processing transaction any other processing transactions with which a conflict has previously been detected.

120. Apparatus for processing data comprising:
a plurality of processor means;
transactional memory means for detecting conflict arising between concurrent processing transactions executed by respective processor means accessing shared data within said transactional memory means;
conflict data store means responsive to said conflicts for storing conflict data for respective processing transactions indicative of with which other processing transactions a conflict has previously been detected; and
scheduling means responsive to said conflict data for scheduling processing transactions to be executed.

121. A computer program product storing a computer program for at least partially controlling an apparatus for processing data to operate in accordance with the method of claim 1.
